(19) United States
(12) Patent Application Publication
(10) Pub. No.: US 2015/0334251 A1
(43) Pub. Date: Nov. 19, 2015

(54) METHOD AND SYSTEMS FOR DYNAMIC SELECTION OF AN ORIGINATING IDENTIFIER FOR BILLING OPTIMIZATION

(71) Applicant: Vonage Network LLC, Holmdel, NJ (US)

(72) Inventor: George Adrian Grabowich, Flemington, NJ (US)

(73) Assignee: VONAGE NETWORK LLC, Holmdel, NJ (US)

(21) Appl. No.: 14/279,915

(22) Filed: May 16, 2014

(51) Int. Cl. H04M 15/00; H04W 8/26

(52) U.S. Cl. CPC H04M 15/771; H04W 8/26; H04M 15/41; H04M 15/8033; H04M 15/8044

(57) ABSTRACT

Methods and systems for dynamic selection of an originating identifier for billing optimization are provided herein. In some embodiments, a method for dynamic selection of an originating identifier for billing optimization may include receiving from a device associated with a user a first communication request containing a first identifier; determining a second identifier from a plurality of identifiers associated with the user, wherein determination of the second identifier is based on a billing rate associated with the first identifier and the second identifier; and transmitting a second communication request to establish a communication using the first identifier as a destination number and the second identifier as an originating number.

### BACKGROUND

1. Field

Embodiments of the present invention generally relate to methods and systems for dynamic selection of an originating number for billing optimization.

2. Description of the Related Art

Telephone communications connect two parties on a call, originating from a calling party telephone number of the caller and directed to a called party telephone number of the party being called. Call set up messages generally require a “From” (i.e., a calling or originating number) and a “To” number (e.g., a called or destination number) pairing set in order to bill the call properly. The “From” and “To” numbers are embedded in the call set up messages and are included in the Call Detail Records (CDRs) used for telecommunication service provider billing. Although Caller ID (CID)/Calling-line identification (CLI) fields can be manipulated for changing how the originating calling party is displayed on the terminating device, the originating and destination numbers in the CDRs are generally not manipulated or changed due to this fundamental billing purpose.

Called and calling number combinations may have different billing rates due to a distance between a geographic area associated with the calling party number and a geographic area associated with the called party number. For example, a call made from a caller's local service area to another phone number within the caller's local service area may accrue lesser charges at a local billing rate than a call originating from a caller's local service area that is directed to a phone number associated with the geographic area of another country, thereby accruing charges at an international billing rate.

A practice of subscriber identity module (SIM) swapping involves a user of a mobile phone manually changing their identity on their mobile device by swapping a SIM chip associated with a first mobile telephone number to a SIM chip associated with a second mobile telephone number. The purpose of swapping the SIM chip is to change a user's phone number in order to appear to be on a different network for the purpose of reducing the user's cellular billing rates. This practice is highly manual and requires a reboot of the mobile phone each time the SIM chip is swapped.

However, a user may be associated with, or otherwise have access to multiple telephone numbers, depending on the user's personal needs. Each of the user's telephone numbers is associated with a different physical location to which the phone number is geographically tied. For example, a user may have a smartphone that includes a mobile app, such as a Voice over Internet Protocol (VoIP) app. The mobile app can accept a plurality of telephone number identities in addition to its embedded smartphone hardware based mobile telephone number. As such, the user may have a US telephone number with a 732 area code associated with a geographical area of New Jersey in the United States. The user may also have a UK telephone number associated with a geographical area of London in the United Kingdom if, for example, the user conducts substantial business in the UK, or has family in the UK. The user may place a call from a geographic area tied to the 732 area to a telephone number in the UK. The billing rate for the call may less if the call were initiated from the user's telephone number that is geographically associated with the UK number, even though the user is not be located in the UK.

Thus, there is a need for a method and apparatus for dynamic selection of a calling party number for billing optimization.

### SUMMARY

Methods and systems for dynamic selection of an originating number for billing optimization are provided herein. In some embodiments, a method for dynamic selection of a calling party number for billing optimization may include receiving from a device associated with a user a first communication request containing a first identifier; determining a second identifier from a plurality of identifiers associated with the user, wherein determination of the second identifier is based on a billing rate associated with the first identifier and the second identifier; and transmitting a second communication request to establish a communication using the first identifier as a destination number and the second identifier as the originating number.

In some embodiments, a system for dynamic selection of an originating identifier for billing optimization may include a routing table that stores routing information to connect a first identifier to a second identifier; a routing rules module configured to provide billing guidelines across a plurality of geographic areas; and a call optimization module configured to receive from a device associated with a user a first communication request containing a first identifier; determine a second identifier from a plurality of identifiers associated with a user, wherein determination of the second identifier is based on a billing rate associated with the first identifier and the second identifier; and transmit a second communication request to establish a communication using the first identifier as a destination number and the second identifier as the originating number.

In some embodiments, a computer readable medium for storing computer instructions that, when executed by at least one processor causes the at least one processor to perform the method for dynamic selection of an originating identifier for billing optimization.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a telecommunication network, according to one or more embodiments of the invention;

FIG. 2 depicts a block diagram of a system for dynamic selection of a calling party number for billing optimization, according to one or more embodiments of the invention;

FIG. 3 depicts a flow diagram of a method 300 for dynamic selection of a calling party number for billing optimization, according to one or more embodiments; and

FIG. 4 depicts a computer system that can be utilized in various embodiments of the present invention, according to one or more embodiments of the invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention generally relate to methods and systems for dynamic selection of a calling party number for billing optimization. More specifically, embodiments of the present invention facilitate selecting a calling party number from a plurality of telephone numbers associated with a user account of a user (i.e., caller). A destination number of the party to whom a call is being placed is identified. The user may have two or more telephone numbers associated with the user's account, where each telephone number is associated with a different geographic region. One of the two or more telephone numbers associated with the user is selected such that the billing rate from the selected telephone number to the destination number is optimized (e.g., cheapest).

For example, a user may own, or otherwise be associated with two or more telephone numbers. The telephone numbers are associated with a user via a mobile app account, for example, a Voice over Internet Protocol (VOIP) telecommunication app account. A first telephone number of the user may be have a US 732 area code that is associated with a geographic area of New Jersey in the United States. A second telephone number of the user may have a US 310 area code that is associated with a geographic area of California in the United States. A third telephone number of the user may have a UK 020 area code that is associated with a geographic area of London in the UK.

When the user places an outgoing call using the mobile app, any of the user's telephone numbers may be selected as the originating telephone number for the outgoing call based on the destination telephone number. For example, the user may place the outgoing call from New Jersey to a destination number in the UK; typically the call is made from the 732 area code number to the destination number in the UK. However, international billing rates between NJ and the UK may be higher than in-country billing rates between two UK telephone numbers. In some instances, an international call may have less expensive billing rates than in-country calls. As such, embodiments of the present invention identify each telephone number associated with a user's account and select the telephone number that has an optimal billing rate between the selected telephone number and the destination number. In the present example, the user's UK telephone number may be selected because the UK telephone number is associated with a geographic region closer to the destination number and therefore is determined to have a more optimal billing rate. The call is then initiated from the user's UK 020 telephone number to the destination party, thereby making the call an in-country call rather than an international call.

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Some exemplary embodiments described below are with respect to a mobile Voice over Internet Protocol (VOIP) telecommunication app. However, one skilled in the art will readily recognize from the following description that any application that relies on or uses address books/contact directories may be used in embodiments consistent with the present invention without departing from the principles of the disclosure described herein.

In the following description, the terms VOIP system, VOIP telephony system, IP system and IP telephony system are all intended to refer to a system that connects callers and that delivers data, text and video communications using Internet protocol data communications. Those of ordinary skill in the art will recognize that embodiments of the present invention are not limited to use with IP telephony systems and may also be used in other systems.

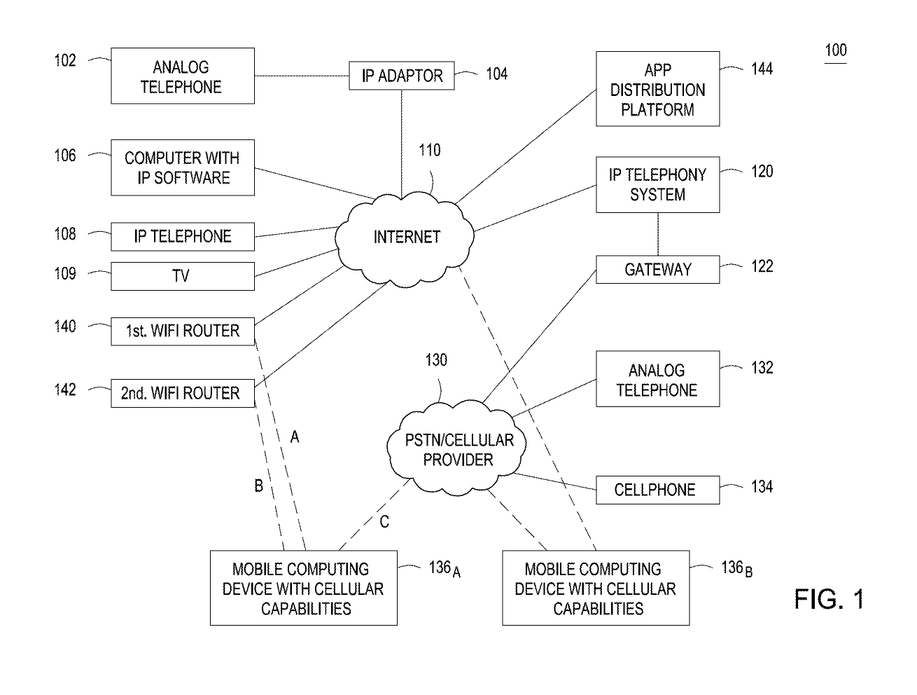

As illustrated in FIG. 1, a communications environment 100 is provided to facilitate IP enhanced communications. An IP telephony system 120 enables connection of telephone calls between its own customers and other parties via data communications that pass over a data network 110. The data network 110 is commonly the Internet, although the IP telephony system 120 may also make use of private data networks. The IP telephony system 120 is connected to the Internet 110. In addition, the IP telephony system 120 is connected to a publicly switched telephone network (PSTN) 130 via a gateway 122. The PSTN 130 may also be directly coupled to the Internet 110 through one of its own internal gateways (not shown). Thus, communications may pass back and forth between the IP telephony system 120 and the PSTN 130 through the Internet 110 via a gateway maintained within the PSTN 130.

The gateway 122 allows users and devices that are connected to the PSTN 130 to connect with users and devices that are reachable through the IP telephony system 120, and vice versa. In some instances, the gateway 122 would be a part of the IP telephony system 120. In other instances, the gateway 122 could be maintained by a third party.

Customers of the IP telephony system 120 can place and receive telephone calls using an IP telephone 108 that is connected to the Internet 110. Such an IP telephone 108 could be connected to an Internet service provider via a wired connection or via a wireless router. In some instances, the IP telephone 108 could utilize a packet-switched network of a cellular telephone system to access the Internet 110.

Alternatively, a customer could utilize an analog telephone 102 which is connected to the Internet 110 via a telephone adapter 104. The telephone adapter 104 converts analog signals from the telephone 102 into data signals that pass over the Internet 110, and vice versa. Analog telephone devices include but are not limited to standard telephones and document imaging devices such as facsimile machines. A configuration using a telephone adapter 104 is common where the analog telephone 102 is located in a residence or business. Other configurations are also possible where multiple analog telephones share access through the same IP adaptor. In those situations, all analog telephones could share the same telephone number, or multiple communication lines (e.g., additional telephone numbers) may provisioned by the IP telephony system 120.

In addition, a customer could utilize a soft-phone client running on a computer 106 or a television 109 to place and receive IP based telephone calls, and to access other IP telephony systems (not shown). The computer 106 may be a personal computer (PC), a tablet device, a gaming system, and the like. In some instances, the soft-phone client could be assigned its own telephone number. In other instances, the soft-phone client could be associated with a telephone number that is also assigned to an IP telephone 108, or to a telephone adaptor 104 that is connected one or more analog telephones 102.

Users of the IP telephony system 120 are able to access the service from virtually any location where they can connect to the Internet 110. Thus, a customer could register with an IP telephony system provider in the U.S., and that customer could then use an IP telephone 108 located in a country outside the U.S. to access the services. Likewise, the customer could also utilize a computer outside the U.S. that is running a soft-phone client to access the IP telephony system 120.

A third party using an analog telephone 132 which is connected to the PSTN 130 may call a customer of the IP telephony system 120. In this instance, the call is initially connected from the analog telephone 132 to the PSTN 130, and then from the PSTN 130, through the gateway 122 to the IP telephony system 120. The IP telephony system 120 then routes the call to the customer's IP telephony device. A third party using a cellular telephone 134 could also place a call to an IP telephony system customer, and the connection would be established in a similar manner, although the first link would involve communications between the cellular telephone 134 and a cellular telephone network. For purposes of this explanation, the cellular telephone network is considered part of the PSTN 130.

In the following description, references will be made to an “IP telephony device.” This term is used to refer to any type of device which is capable of interacting with an IP telephony system to complete an audio or video telephone call or to send and receive text messages, and other forms of communications. An IP telephony device could be an IP telephone, a computer running IP telephony software, a telephone adapter which is itself connected to a normal analog telephone, or some other type of device capable of communicating via data packets. An IP telephony device could also be a cellular telephone or a portable computing device that runs a software application that enables the device to act as an IP telephone. Thus, a single device might be capable of operating as both a cellular telephone that can facilitate voice based session calls, and an IP telephone that can facilitate data based session calls.

The following description will also refer to a mobile telephony device. The term “mobile telephony device” is intended to encompass multiple different types of devices. In some instances, a mobile telephony device could be a cellular telephone. In other instances, a mobile telephony device may be a mobile computing device, such as the APPLE IPHONE, that includes both cellular telephone capabilities and a wireless data transceiver that can establish a wireless data connection to a data network. Such a mobile computing device could run appropriate application software to conduct VoIP telephone calls via a wireless data connection. Thus, a mobile computing device, such as an APPLE IPHONE, a RIM BLACKBERRY or a comparable device running GOOGLE ANDROID operating system could be a mobile telephony device.

In still other instances, a mobile telephony device may be a device that is not traditionally used as a telephony device, but which includes a wireless data transceiver that can establish a wireless data connection to a data network. Examples of such devices include the APPLE IPOD TOUCH and the IPAD. Such a device may act as a mobile telephony device once it is configured with appropriate application software.

FIG. 1 illustrates that a mobile computing device with cellular capabilities 136A (e.g., a smartphone) is capable of establishing a first wireless data connection A with a first wireless access point 140, such as a WiFi or WiMax router. The first wireless access point 140 is coupled to the Internet 110. Thus, the mobile computing device 136A can establish a VOIP telephone call with the IP telephony system 120 via a path through the Internet 110 and the first wireless access point 140.

FIG. 1 also illustrates that the mobile computing device 136A can establish a second wireless data connection B with a second wireless access point 142 that is also coupled to the Internet 110. Further, the mobile computing device 136A can establish either a third wireless data connection C via a packet-switch network provided by a cellular service provider 130 using its cellular telephone capabilities, or establish a voice based session telephone call via a circuit-switched network provided by a cellular service provider 130. The mobile computing device 136A could also establish a VoIP telephone call with the IP telephony system 120 via the second wireless connection B or the third wireless connection C.

Although not illustrated in FIG. 1, the mobile computing device 136A may be capable of establishing a wireless data connection to a data network, such as the Internet 110, via alternate means. For example, the mobile computing device 136A might link to some other type of wireless interface using an alternate communication protocol, such as the WIMAX standard.

Similarly, mobile computing device with cellular capabilities 136B may also be coupled to internet 110 and/or cellular service provider 130. In some embodiments, mobile computing device 136B may be connected to internet 110 via a WIFI or WIMAX connection, and the like, and can also establish a VOIP telephone calls with the IP telephony system 120 similar to mobile computing device 136A. In embodiments of the present invention, communications environment 100 may be used to establish voice based or data based telecommunications sessions between mobile computing device 136A and mobile computing device 136B, depending on various criteria associated with each of the mobile computing devices, as will be described below in more detail.

In the embodiments described above, a device may act as a mobile telephony device once it is configured with appropriate application software that may be downloaded from an app distribution platform 144. For example, mobile computing device 136A may download a VOIP mobile app from app distribution platform 144 and install the VOIP mobile app on mobile computing device 136A. In some exemplary embodiments described below, mobile computing devices 136A and 136B are on different service provider networks and communications between mobile computing devices 136A and 136B are “off-net” communications. When mobile computing devices 136A and 136B are on the same service provider network, communications between mobile computing devices 136A and 136B are considered “on-net” communications.

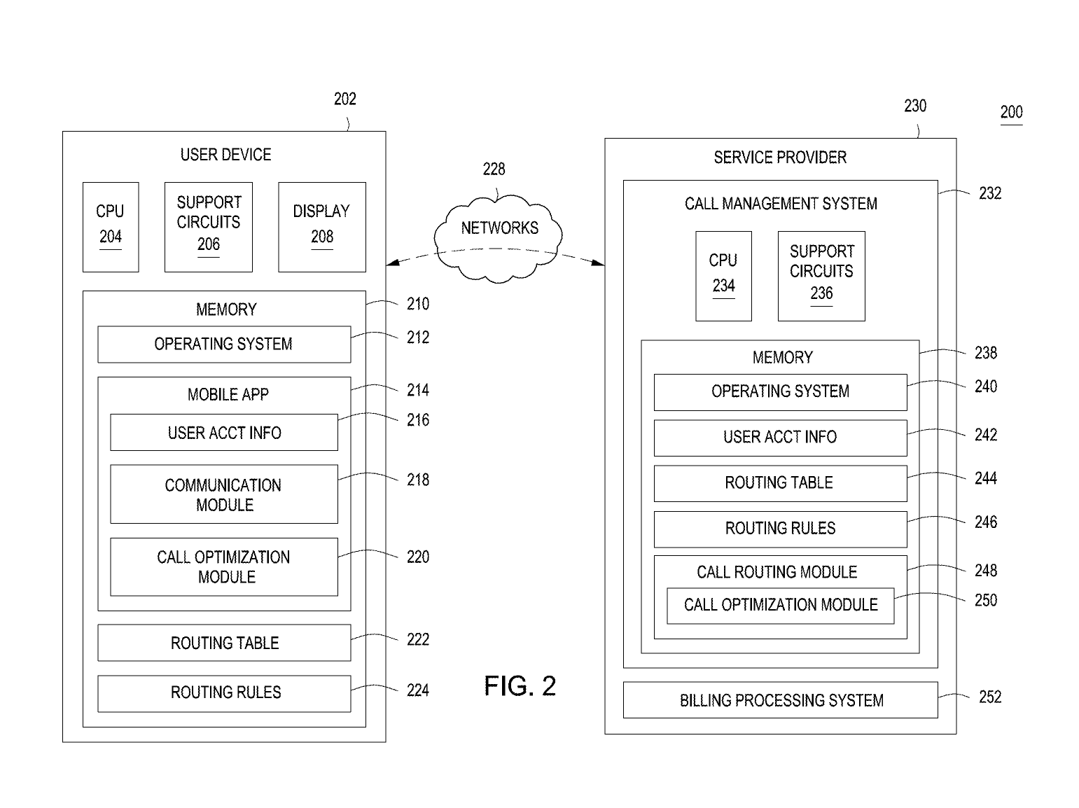

FIG. 2 depicts a block diagram of a system 200 for dynamic selection of a calling party number for billing optimization, according to one or more embodiments. The system 200 comprises a user device 202 and service provider system 230 communicatively coupled via networks 228. In some embodiments, the user device 202 may be a mobile computing device (e.g., 136A) associated with a user, and service provider system 230 may be IP telephony system 120 as described above in FIG. 1.

The user device 202 may comprise a Central Processing Unit (CPU) 204, support circuits 206, a display 208, and a memory 210. The CPU 204 may comprise one or more commercially available microprocessors or microcontrollers that facilitate data processing and storage. The various support circuits 206 facilitate the operation of the CPU 204 and include one or more clock circuits, power supplies, cache, input/output device and circuits, and the like. The memory 210 comprises at least one of Read Only Memory (ROM), Random Access Memory (RAM), disk drive storage, optical storage, removable storage and/or the like. In some embodiments, the memory 210 comprises an operating system 212, a mobile app 214, such as a VoIP mobile telecommunication app, a routing table 222, and routing rules 224.

The operating system (OS) 212 generally manages various computer resources (e.g., network resources, file processors, and/or the like). The operating system 212 is configured to execute operations on one or more hardware and/or software modules, such as Network Interface Cards (NICs), hard disks, virtualization layers, firewalls and/or the like. Examples of the operating system 212 may include, but are not limited to, various versions of LINUX, MAC OSX, BSD, UNIX, MICROSOFT WINDOWS, IOS, ANDROID and the like. In some embodiments, operating system 212 may include an application programming interface (API) which can be used to access and user device information and features (such as, for example, by mobile app 214).

The mobile app 214 may be any communications app that uses account information. In some embodiments, the mobile app 214 is a VoIP app that provides over-the-top (OTT) VoIP telephony services to an end-user. In some embodiments, an end-user may download the mobile app 214 from service provider system 230, or from an app distribution system 144, and install the mobile app 214 on their device. Although the mobile app 214 is described herein as a separate stand-alone application, in some embodiments the mobile app 214 may be integrated into OS 212, and may use existing API calls provided by the OS 212 to access or control various features of user device 202.

In some embodiments mobile app 214 may include user account information 216, a communication module 218, and a call optimization module 220. In some embodiments, the user account information 216 may include two or more telephone numbers associated with, or otherwise assigned to, a user as well as the geographic area to which each telephone number is tied. Communication module 218 may be used to facilitate, otherwise provide, communication services such as, for example, voice or video calling, SMS messages, email, or various other types of communication services provided by a service provider 230. In some embodiments, the call optimization module 220 may be used to help manage/optimize calls using routing table 222 and routing rules 224, and also to interface/communicate with a remote call management system, such as, for example, call management system 232. In some embodiments, the routing table 222 and routing rules 224 are retrieved from the service provider 230 and stored locally on the user device 202.

The networks 228 comprise one or more communication systems that connect computers by wire, cable, fiber optic and/or wireless link facilitated by various types of well-known network elements, such as hubs, switches, routers, and the like. The networks 228 may include an Internet Protocol (IP) network (such as internet 110 of FIG. 1), a public switched telephone network (PSTN) (such as the PSTN network of PSTN provider 130 of FIG. 1), or other mobile communication networks, and may employ various well-known protocols to communicate information amongst the network resources.

In some embodiments, service provider 230 may be a communication service provider, such as a VoIP service provider, that includes and maintains call management system 232 and a billing processing system 252. In other embodiments, call management system 232 may be a separate entity that provides contact management services to service provider system 230, or to individual users, by agreement. In some embodiments, billing processing system 252 may be a separate entity that provides billing services to service provider system 230. Service provider 230 may include call management system 232 that may be used to manage calls in order to optimize billing costs associated with a user. The call management system 232 may include a Central Processing Unit (CPU) 234, support circuits 236, and memory 238. The CPU 234 may comprise one or more commercially available microprocessors or microcontrollers that facilitate data processing and storage. The various support circuits 236 facilitate the operation of the CPU 234 and include one or more clock circuits, power supplies, cache, input/output circuits, and the like. The memory 238 comprises at least one of Read Only Memory (ROM), Random Access Memory (RAM), disk drive storage, optical storage, removable storage and/or the like. In some embodiments, the memory 238 comprises an operating system 240, user account information 242, a routing table 244, routing rules 246, and a call routing module 248. The call routing module 248 includes a call optimization module 250. The operating system (OS) 240 generally manages various computer resources (e.g., network resources, file processors, and/or the like). The operating system 240 is configured to execute operations on one or more hardware and/or software modules, such as Network Interface Cards (NICs), hard disks, virtualization layers, firewalls and/or the like. Examples of the operating system 240 may include, but are not limited to, various versions of LINUX, MAC OSX, BSD, UNIX, MICROSOFT WINDOWS, 10S, ANDROID and the like.

The routing table 244 includes routing information that connects calls between different geographic areas or jurisdictions or call media types (e.g., voice or SMS). The routing table 244 includes indications of gateways to use to route calls through networks 228. The routing table 244 may be used to identify one or more routes to connect an originating telephone number to a destination telephone number. The routing rules 246 provide general billing guidelines across jurisdictions. The routing rules 246 may be used to determine a billing rate for each route identified using the routing table 244. The routing table 244 may be updated manually or automatically by a carrier.

In some embodiments, user account information 242 may store two or more telephone numbers associated with a user in addition to a geographic area associated with each of the two or more telephone numbers. For example, the user account information 242 for a user may include a first telephone number that has a US 732 area code that is associated with a geographic area of New Jersey in the United States. The user account information 242 may include a second telephone number that has a US 310 area code that is associated with a geographic area of California in the United States. The user account information 242 may include a third telephone number may have a UK 020 area code that is associated with a geographic area of London in the UK.

In some embodiments, the call optimization module 220 on user device 202 performs calling number billing optimization process. In such embodiments, when the user makes a call to a given destination number, call optimization module 220 accesses the routing table 222 and routing rules 224. The call optimization module 220 uses the routing table 222 to identify one or more routes that connect each telephone number in the user account information 242 to the given destination. The call optimization module 220 uses routing rules 224 to identify a most optimal billing route for the call based on the identified routes. The call optimization module 220 determines the calling number of the user that provides the most optimal billing rate to connect to the given destination and originates the call from the determined calling number. In some embodiments, the calling number billing optimization determination process is performed by the service provider 230. In such embodiments, a call optimization module 250 included in the call routing module 248 identifies the optimal billing calling number using the routing table 244 and routing rules 246. The call management system 232 generates a call data record (CDR) using the identified optimal billing calling number and provides the CDR to the billing processing system 252.

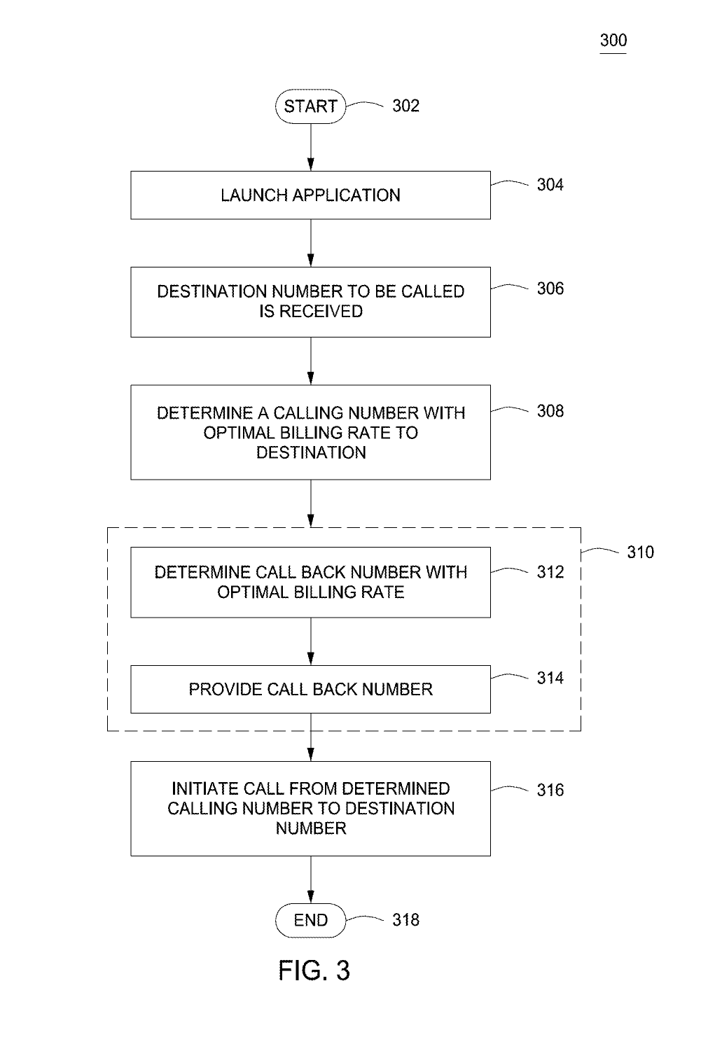

FIG. 3 depicts a flow diagram of a method 300 for dynamic selection of a calling party number for billing optimization, according to one or more embodiments of the subject invention. The method 300 begins at 302 and proceeds to 304 where a user launches an application, such as mobile app 218, on a device associated with the user. The method 300 proceeds to step 306, where a destination telephone number to be called by a user device associated with the user is received. In some embodiments, the called destination number may be received in a call request. In some embodiments, the call request may be sent/received via signaling messages of telecommunication protocols (e.g., SS7, C7, ISDN, SIP, H.323, and the like). In some embodiments, the call request may be a SIP INVITE message. The user of the device is associated with two or more telephone numbers where each telephone number is associated with a different physical location to which the telephone number is geographically tied. Call information associated with the call is generated. The call information includes a destination telephone number that identifies the party who is being called.

The method 300 proceeds to step 308, where the call optimization module 220 determines which of the user's two or more telephone numbers would provide the optimal (e.g., cheapest) billing rate when calling the destination telephone number. A routing table is accessed to determine one or more routes that could connect each of the two or more telephone numbers of the user to the destination telephone number. The routing table includes indications of gateways to use to route calls through networks. Said gateways are used to identify one or more routes to connect an originating telephone number to the destination telephone number. Routing rules are used to identify which of the routes from which of the two or more telephone numbers optimizes the billing rate for the call. In some embodiments, determining which of the user's two or more telephone numbers would provide the optimal billing rate when calling the destination telephone number is performed by the call routing module 248 at the service provider 230.

In some embodiments, the method 300 optionally proceeds to block 310, where a callback number is selected for display at the call destination that may provide an optimal billing rate for a callback from the destination telephone number to the user. At step 312, the call optimization module 220 determines which of the user's two or more telephone numbers may provide the optimal (i.e. cheapest) billing rate when called back by the destination telephone number.

In some embodiments, where the out-going call to the destination telephone number is an “on-net” communication, a callback number with an optimal billing rate is determined. In an on-net communication, a same service provider is shared by both parties in the call. As such, the service provider can determine an optimal callback billing rate for the destination telephone number. The routing table is accessed to identify one or more routes that could connect the destination telephone number to each of the two or more telephone numbers of the user. Routing rules are used to identify which of the routes from the destination telephone number to which of the two or more telephone numbers optimizes the billing rate for the callback. In such embodiments, determining which of the user's two or more telephone numbers would provide the optimal billing rate when called by the destination telephone number is performed by the call routing module 248 at the service provider 230.

In some embodiments, where the out-going call to the destination telephone number is an “off-net” communication, a callback number is determined based on a shortest distance between the geographic areas associated with each of the user's two or more telephone numbers and the geographic area associated with the destination telephone number is determined. Due to the fact that the callback billing rates for the destination telephone number are not known, a callback number based on the shortest distance between the geographic area associated with each of the user's two or more telephone numbers and the geographic area associated with the destination telephone number is likely, although not guaranteed, to provide an optimal billing rate. In such embodiments, the routing table is accessed to identify one or more routes that could connect the destination telephone number to each of the two or more telephone numbers. The telephone number associated with the route determined to be the “shortest” (i.e., covering the least geographic distance) is selected as the callback number. In some embodiments, factors other than geographic distance may be used to provide an optimal billing rate. One or more factors and/or assumptions may be used to determine an optimal billing rate for a route. For example, assumptions regarding the destination telephone number's provider's routing tables or contracts may be used to determining a billing rate. Alternatively, assumptions regarding a likely time of day for a callback may be factored into a determination of a billing rate for the callback.

The method 300 proceeds to step 314, where the determined number for callback is provided in a call set up message as a caller ID.

The method 300 proceeds to step 316, where the communication module 218 initiates the call from the determined user telephone number to the destination telephone number and optionally provides the determined optimal callback number as the caller ID. In embodiments in which the callback number that provides the optimal billing rate is not determined, the determined user telephone number that provides the optimal billing rate to the destination telephone number may be used as the caller ID. A call detail record (CDR) is generated for each carrier involved in routing the initiated call. The CDRs include the same “To” number and “From” number, where the “From” number is the determined user telephone number that provides the optimal billing rate, and the “To” number is the destination telephone number. The CDR is used for telecommunication service provider billing.

The method 300 proceeds to step 318 and ends.

The embodiments of the present invention may be embodied as methods, apparatus, electronic devices, and/or computer program products. Accordingly, the embodiments of the present invention may be embodied in hardware and/or in software (including firmware, resident software, micro-code, and the like), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a non-exhaustive list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

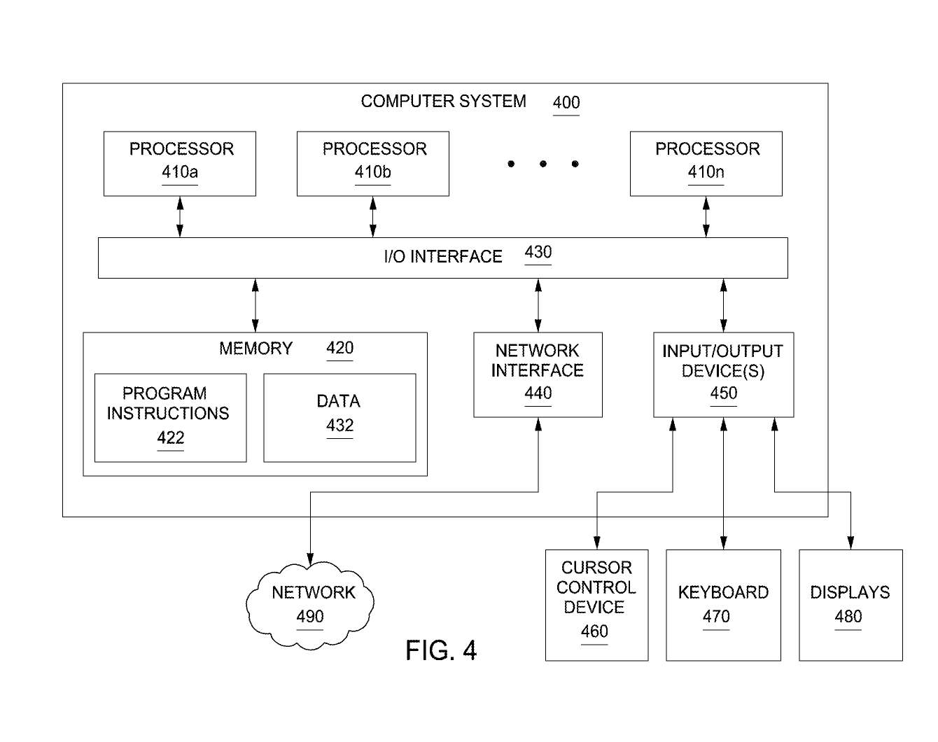

FIG. 4 depicts a computer system 400 that can be utilized in various embodiments of the present invention to implement the computer and/or the display, according to one or more embodiments.

Various embodiments of method and apparatus for organizing, displaying and accessing contacts in a contact list, as described herein, may be executed on one or more computer systems, which may interact with various other devices. One such computer system is computer system 400 illustrated by FIG. 4, which may in various embodiments implement any of the elements or functionality illustrated in FIGS. 1-3. In various embodiments, computer system 400 may be configured to implement methods described above. The computer system 400 may be used to implement any other system, device, element, functionality or method of the above-described embodiments. In the illustrated embodiments, computer system 400 may be configured to implement the method 300 as processor-executable executable program instructions 422 (e.g., program instructions executable by processor(s) 410) in various embodiments.

In the illustrated embodiment, computer system 400 includes one or more processors 410a-410n coupled to a system memory 420 via an input/output (I/O) interface 430. Computer system 400 further includes a network interface 440 coupled to I/O interface 430, and one or more input/output devices 450, such as cursor control device 460, keyboard 470, and display(s) 480. In various embodiments, any of the components may be utilized by the system to receive user input described above. In various embodiments, a user interface may be generated and displayed on display 480. In some cases, it is contemplated that embodiments may be implemented using a single instance of computer system 400, while in other embodiments multiple such systems, or multiple nodes making up computer system 400, may be configured to host different portions or instances of various embodiments. For example, in one embodiment some elements may be implemented via one or more nodes of computer system 400 that are distinct from those nodes implementing other elements. In another example, multiple nodes may implement computer system 400 in a distributed manner.

In different embodiments, computer system 400 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 400 may be a uniprocessor system including one processor 410, or a multiprocessor system including several processors 410 (e.g., two, four, eight, or another suitable number). Processors 410 may be any suitable processor capable of executing instructions. For example, in various embodiments processors 410 may be general-purpose or embedded processors implementing any of a variety of instruction set architectures (ISAs). In multiprocessor systems, each of processors 410 may commonly, but not necessarily, implement the same ISA.

System memory 420 may be configured to store program instructions 422 and/or data 432 accessible by processor 410. In various embodiments, system memory 420 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 420. In other embodiments, program instructions and/or data may be received, sent or stored upon different types of computer-accessible media or on similar media separate from system memory 420 or computer system 400.

In one embodiment, I/O interface 430 may be configured to coordinate I/O traffic between processor 410, system memory 420, and any peripheral devices in the device, including network interface 440 or other peripheral interfaces, such as input/output devices 450. In some embodiments, I/O interface 430 may perform any necessary protocol, timing or other data transformations to convert data signals from one component (e.g., system memory 420) into a format suitable for use by another component (e.g., processor 410). In some embodiments, I/O interface 430 may include support for devices attached through various types of peripheral buses, such as a variant of the Peripheral Component Interconnect (PCI) bus standard or the Universal Serial Bus (USB) standard, for example. In some embodiments, the function of I/O interface 430 may be split into two or more separate components, such as a north bridge and a south bridge, for example. Also, in some embodiments some or all of the functionality of I/O interface 430, such as an interface to system memory 420, may be incorporated directly into processor 410.

Network interface 440 may be configured to allow data to be exchanged between computer system 400 and other devices attached to a network (e.g., network 490), such as one or more external systems or between nodes of computer system 400. In various embodiments, network 490 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 440 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 450 may, in some embodiments, include one or more display terminals, keyboards, keypads, touchpads, scanning devices, voice or optical recognition devices, or any other devices suitable for entering or accessing data by one or more computer systems 400. Multiple input/output devices 450 may be present in computer system 400 or may be distributed on various nodes of computer system 400. In some embodiments, similar input/output devices may be separate from computer system 400 and may interact with one or more nodes of computer system 400 through a wired or wireless connection, such as over network interface 440.

In some embodiments, the illustrated computer system may implement any of the operations and methods described above, such as the methods illustrated by the flowcharts of FIG. 3. In other embodiments, different elements and data may be included.

Those skilled in the art will appreciate that computer system 400 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 400 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 400 may be transmitted to computer system 400 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A method for dynamic selection of an originating identifier for billing optimization, comprising:
receiving from a device associated with a user a first communication request containing a first identifier;
determining a second identifier from a plurality of identifiers associated with the user, wherein determination of the second identifier is based on a billing rate associated with the first identifier and the second identifier; and
transmitting a second communication request to establish a communication using the first identifier as a destination number and the second identifier as the originating identifier.

2. The method of claim 1, wherein the billing rate is based on geographic locations associated with each of the first identifier and the second identifier.

3. The method of claim 1, further comprising:
causing a billing call detail record to be created and sent to a billing system, wherein the call detail record includes the first identifier as the destination number and the second identifier as the originating number.

4. The method of claim 1, further comprising:
determining a third identifier from the plurality of identifiers associated with the user, wherein determination of the third identifier is based on an indication of a billing rate associated with the first identifier and the third identifier; and
providing the third identifier as a callback number.

5. The method of claim 4, wherein the indication of the billing rate is based on a shortest distance between a geographic area associated with the first identifier and a geographic area associated with the third identifier.

6. The method of claim 4, wherein the second and third identifiers are different.

7. The method of claim 4, wherein the second and third identifiers are associated with a telecommunication service provider account of the user, and wherein the second and third identifiers are associated with different geographic locations.

8. The method of claim 1, wherein the first communication request is received from a Voice over Internet Protocol (VOIP) telecommunication app.

9. The method of claim 1, wherein determining a second identifier comprises:
determining one or more routes that connect each identifier of the plurality of identifiers associated with the user to the first identifier;
determining a billing rate for each of the one or more determined routes; and
determining a second identifier that is associated with a route having a lowest billing rate.

10. The method of claim 9, wherein determining one or more routes comprises:
accessing a routing table that provides routing information for connecting telephone communications across a plurality of geographic areas; and
accessing routing rules that provide billing information for each connection from a first geographic area to a second geographic area.

11. A system for dynamic selection of an originating identifier for billing optimization, comprising:
a routing table that stores routing information to connect a first identifier to a second identifier;
a routing rules module configured to provide billing guidelines across a plurality of geographic areas; and
a call optimization module configured to receive from a device associated with a user a first communication request containing a first identifier; determine a second identifier from a plurality of identifiers associated with a user, wherein determination of the second identifier is based on a billing rate associated with the first identifier and the second identifier; and transmit a second communication request to establish a communication using the first identifier as a destination number and the second identifier as an originating number.

12. The system of claim 11, wherein the billing rate is based on geographic locations associated with each of the first identifier and the second identifier.

13. The system of claim 11, wherein the call optimization module is further configured to cause a billing call detail record to be created and sent to a billing system, wherein the call detail record includes the first identifier as the destination number and the second identifier as the originating number.

14. The system of claim 11, wherein the call optimization module is further configured to:
determine a third identifier from the plurality of identifiers associated with the user, wherein determination of the third identifier is based on an indication of a billing rate associated with the first identifier and the third identifier; and
provide the third identifier as a callback number,
wherein the second and third identifiers are different.

15. The system of claim 14, wherein the indication of the billing rate is based on a shortest distance between a geographic area associated with the first identifier and a geographic area associated with the third identifier.

16. The system of claim 14, wherein the second and third identifiers are associated with a telecommunication service provider account of the user, and wherein the second and third identifiers are associated with different geographic locations.

17. The system of claim 11, wherein the first communication request is received from a Voice over Internet Protocol (VOIP) telecommunication app.

18. The system of claim 11, wherein determining a second identifier comprises:
determining one or more routes that connect each identifier of the plurality of identifiers associated with the user to the first identifier;
determining a billing rate for each of the one or more determined routes; and
identifying a second identifier that is associated with a route having a lowest billing rate.

19. The system of claim 18, wherein determining one or more routes comprises:
accessing a routing table that provides routing information for connecting telephone communications across a plurality of geographic areas; and
accessing routing rules that provide billing information for each connection from a first geographic area to a second geographic area.

20. A non-transitory computer readable medium for storing computer instructions that, when executed by at least one processor causes the at least one processor to perform a method for dynamic selection of an originating identifier for billing optimization comprising:
receiving from a device associated with a user a first communication request containing a first identifier;
determining a second identifier from a plurality of identifiers associated with the user, wherein determination of the second identifier is based on a billing rate associated with the first identifier and the second identifier; and
transmitting a second communication request to establish a communication using the first identifier as a destination number and the second identifier as an originating number.

21. The computer readable medium of claim 20, wherein the billing rate is based on geographic locations associated with the first identifier and the second identifier.

22. The computer readable medium of claim 20, further comprising:
causing a billing call detail record to be created and sent to a billing system, wherein the call detail record includes the first identifier as the destination number and the second identifier the originating number.
